(19) United States
(12) Patent Application Publication
(10) Pub. No.: US 2010/0299661 A1
(43) Pub. Date: Nov. 25, 2010

(54) Load-Time Code Optimization In a Computing Environment

(75) Inventors: Daniel Citron, Haifa (IL); Gad Haber, Nesher (IL)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 12/471,410

(22) Filed: May 25, 2009

(51) Int. Cl. G06F 9/45

(52) U.S. Cl. 717/154

(57) ABSTRACT

A method for optimizing program code is provided. The method comprises receiving a request to execute a computer program on a computer system; loading executable code generated for the computer program into memory; optimizing the executable code during the loading; and executing the optimized executable code. The executable code is optimized according to information collected about the computer system, and the optimized executable code and the collected information are stored for use during future optimization of the executable code.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of the claimed subject matter to material associated with such marks.

### TECHNICAL FIELD

The claimed subject matter relates generally to code optimization in a computing environment and, more particularly, to platform-dependent optimization.

### BACKGROUND

A compiler transforms, or compiles, source code for a program code (e.g., a computer program) into executable code so that the program code can be executed by a computing system. The compiler may statically or dynamically optimize the program code to improve performance or reduce consumption of resources by modifying the executable code generated for the program code.

Code optimization is either platform-independent or platform-dependent. A platform refers to the type of execution environment (e.g., an operating system and processor) utilized by a computing system. A platform-independent optimization is effective on most platforms. A platform-dependent optimization, in contrast, targets the particular platform utilized to execute the program code being optimized.

A static compiler optimizes executable code during the compilation of the executable code, before the target platform is known. Thus, the static compiler cannot perform any platform-dependent optimizations unless a user identifies the target platform. If no up-to-date information is available for the target platform because the target platform is either a new or upgraded platform, the target platform cannot be identified by the user.

A dynamic compiler optimizes executable code while the executable code is being executed by a computing system. Since the dynamic compiler has access to information about the computing system during execution, the dynamic compiler can identify the target platform and perform one or more platform-dependent optimizations according to dynamic information.

Unfortunately, because the program code is optimized according to dynamic information, the optimizations may be different each time the program code is executed even if the same executable code is executed by a computing system utilizing a same platform. Thus, it is difficult for developers to test or support a program code where the respective executable code is optimized by a dynamic compiler.

Additionally, if the source code is written in a static programming language (e.g., C, C++, Fortran), the optimizations may result in significant overhead. For example, synchronization barriers and required resources inserted into the executable code may substantially delay execution of the program code if the program code is multi-threaded (i.e., comprises code segments that are executed independently of each other).

### SUMMARY

The present disclosure is directed to systems and corresponding methods that facilitate load-time code optimization in a computing environment.

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a method for optimizing program code is provided. The method comprises receiving a request to execute a computer program on a computer system; loading executable code generated for the computer program into memory; optimizing the executable code during the loading; and executing the optimized executable code. The executable code is optimized according to information collected about the computer system, and the optimized executable code and the collected information are stored for use during future optimization of the executable code.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The claimed subject matter is not, however, limited to any particular embodiment disclosed.

### BRIEF DESCRIPTION OF THE DRAWINGS

Embodiments of the claimed subject matter are understood by referring to the figures in the attached drawings, as provided below.

FIG. 1 illustrates an exemplary computing environment, in accordance with one or more embodiments.

FIG. 2A is a flow diagram of a method for retrieving a saved optimized executable code during load-time, in accordance with one embodiment.

FIG. 2B is a flow diagram of a method for generating an optimized executable code during load-time, in accordance with one embodiment.

FIGS. 3 and 4 are block diagrams of hardware and software environments, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others.

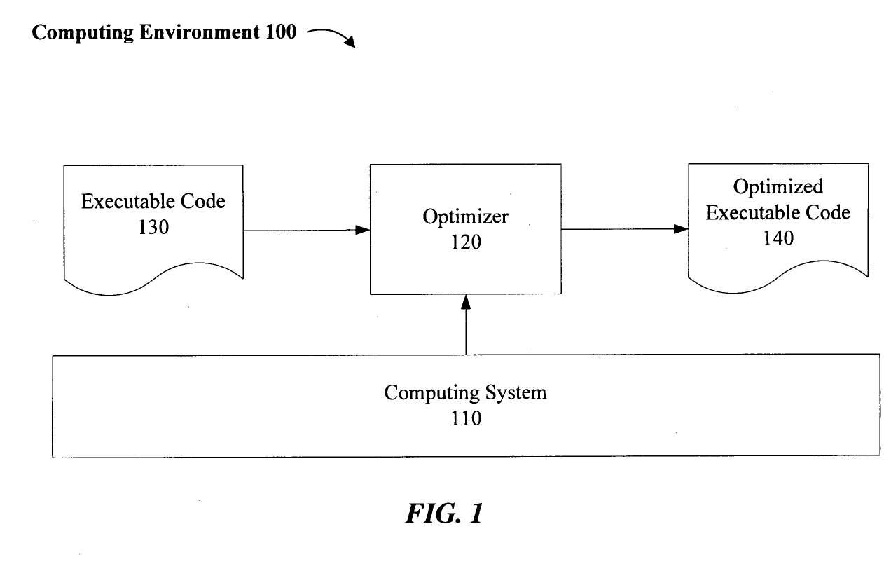

Referring to FIG. 1, in accordance with one embodiment, an exemplary computing environment 100 comprises a computing system 110, which may include various hardware and software components (e.g., an optimizer 120, an operating system, a processor, memory, etc.) for executing a program code.

The computing system 110 may be configured to load an executable code 130 generated for a program code (e.g., a computer program) by a compiler (not shown). A compiler, as provided earlier, transforms, or compiles, source code for a program code into executable code so that the program code can be executed by a computing system. The optimizer 120 may be configured to perform one or more platform-dependent optimizations and generate an optimized executable code 140 for the computing system 110 to execute.

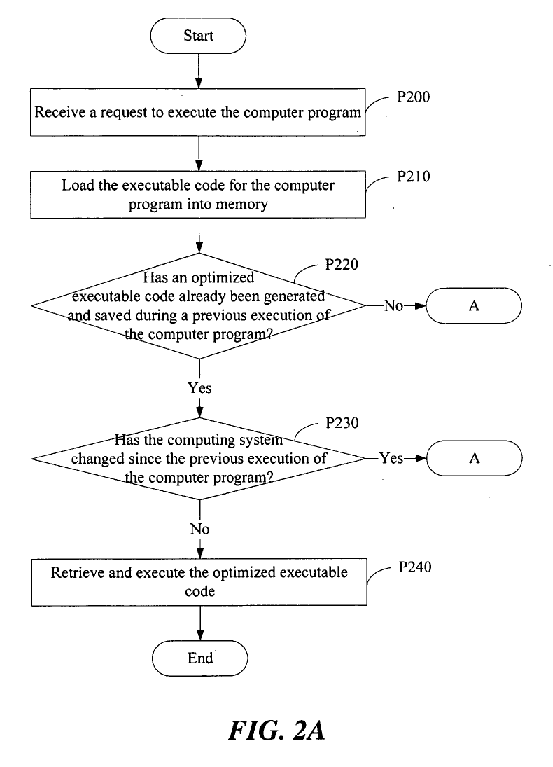

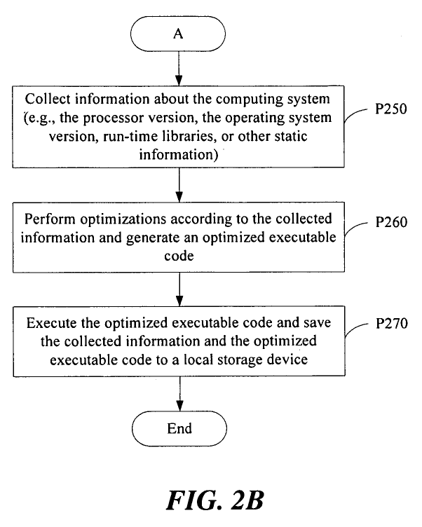

Referring to FIGS. 1 and 2A, in accordance with one embodiment, the computing system 110 receives a request to execute a computer program (P200). In response to the request, the computing system 110 loads the executable code 130 generated for the computer program into memory (P210).

During the loading process, the optimizer 120 determines whether an optimized executable code 140 was generated and saved during a previous execution of the computer program (P220). The optimizer 120 also determines whether the computing system 110 has changed since the previous execution of the computer program (P230).

If the optimized executable code 140 was generated during the previous execution of the computer program and the computing system 110 has not changed since the previous execution of the computer program, the optimizer 110 retrieves and executes the saved optimized executable code 140 (P240). Otherwise, the optimizer 120 generates the optimized executable code 140, as provided below.

Referring to FIGS. 1 and 2B, in accordance with one embodiment, the optimizer 120 collects information about the computing system 110 (P250). Depending on implementation, the information may comprise one or more of the following: information about system hardware (e.g., level, version, or configuration details of the processor); information about system software (e.g., level, version, or configuration details of the operating system or loaded libraries); dates and storage locations of relevant files (e.g., loaded libraries or the executable code 130); or other relevant information.

Upon collecting the information, the optimizer 120 performs platform-dependent optimizations according to the collected information and generates the optimized executable code 140 (P260). Once the optimized executable code 140 is generated, the computing system 110 executes the generated optimized executable code 140 and saves the collected information and the optimized executable code 140 to a local storage device (P270).

Advantageously, the optimizations may be performed according to static information, so that the same optimized executable code 140 is executed each time the executable code 130 is loaded by the computing system 110 or by a different computing system that utilizes the same platform as the computing system 110. Using the above scheme, a program code can more easily be tested and supported.

In some embodiments, an overhead may be associated with using the optimizer 120 to optimize program code. Such overhead may be reduced over multiple executions of the program code. Once the optimized executable code 140 is generated and saved during an execution of the program code, the optimizations do not have to be performed during subsequent executions of the program code as long as the computing system 110's attributes remain unchanged (e.g., the computing system 110 utilizes the same platform).

In different embodiments, the claimed subject matter may be implemented either entirely in the form of hardware or entirely in the form of software, or a combination of both hardware and software elements. For example, the computing environment 100 may comprise a controlled computing system environment that can be presented largely in terms of hardware components and software code executed to perform processes that achieve the results contemplated by the system of the claimed subject matter.

Referring to FIGS. 1, 3, and 4, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In one embodiment, the optimizer 120 is implemented as application software 1122 executed on one or more hardware environments to perform load-time code optimizations in the computing environment 100. Application software 1122 may comprise but is not limited to program code, data structures, firmware, resident software, microcode or any other form of information or routine that may be read, analyzed or executed by a microcontroller.

In an alternative embodiment, the claimed subject matter may be implemented as computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate or transport the program for use by or in connection with the instruction execution system, apparatus or device.

The computer-readable medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

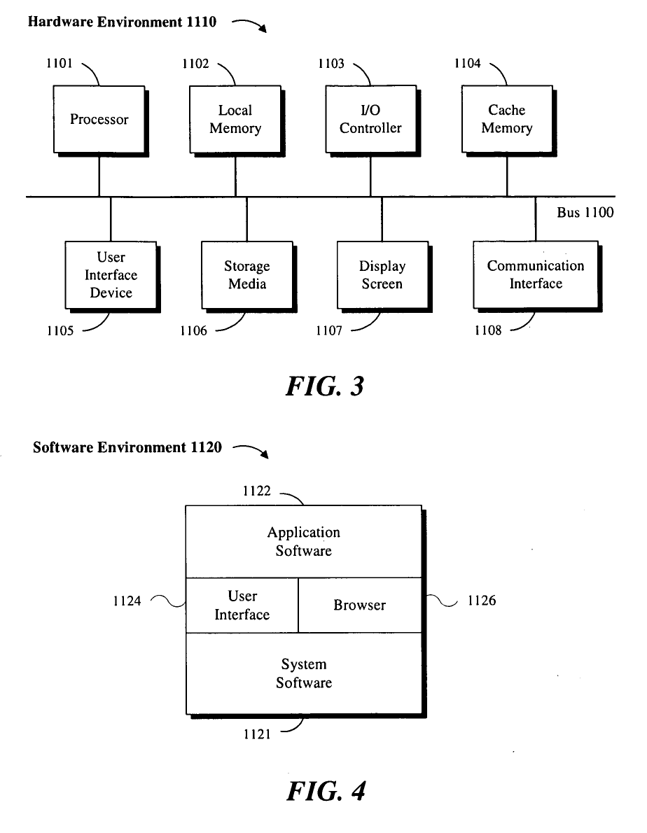

Referring to FIG. 3, an embodiment of the application software 1122 may be implemented as computer software in the form of computer readable code executed on a data processing system such as hardware environment 1110 that comprises a processor 1101 coupled to one or more memory elements by way of a system bus 1100. The memory elements, for example, may comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4, application software 1122 may comprise one or more computer programs that are executed on top of system software 1121 after being loaded from storage media 1106 into local memory 1102. In a client-server architecture, application software 1122 may comprise client software and server software. For example, in one embodiment, client software is executed on a personal computing system and server software is executed on a server system.

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective processes of each method are performed are purely exemplary. Depending on implementation, the processes can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. A method of optimizing program code, the method comprising:
receiving a request to execute a computer program on a computing system;
loading executable code generated for the computer program into memory;
optimizing the executable code during the loading; and
executing the optimized executable code.

2. The method of claim 1, further comprising collecting information about the computing system.

3. The method of claim 2, wherein the optimizing is performed according to the collected information.

4. The method claim 2, wherein the collected information comprises static information.

5. The method of claim 2, wherein the optimizing comprises determining whether the optimized executable code was saved during a previous execution of the computer program.

6. The method of claim 5, wherein the optimizing further comprises determining whether the computing system has changed since the previous execution of the computer program.

7. The method of claim 6, wherein the optimizing further comprises retrieving the optimized executable code from a storage device, in response to determining that the optimized executable code was stored during the previous execution of the computer program and that the computing system's attributes have not changed since the previous execution of the computer program.

8. The method of claim 6, wherein the optimizing further comprises generating the optimized executable code, in response to determining that the optimized executable code was not stored during the previous execution of the computer program or that the computing system attributes have changed since the previous execution of the computer program.

9. The method of claim 8, further comprising storing the optimized executable code in a local storage device.

10. The method of claim 8, further comprising storing the collected information in a local storage device.

11. A system for optimizing program code, the system comprising:
a logic unit for receiving a request to execute a computer program;
a logic unit for loading executable code generated for the computer program into memory;
a logic unit for optimizing the executable code during the loading; and
a logic unit for executing the optimized executable code.

12. The method of claim 11, further comprising a logic unit for collecting information about the system.

13. The method of claim 12, wherein the optimizing is performed according to the collected information.

14. The method claim 12, wherein the collected information comprises static information.

15. The method of claim 12, wherein the optimizing comprises determining whether the optimized executable code was saved during a previous execution of the computer program.

16. The method of claim 15, wherein the optimizing further comprises determining whether the system has changed since the previous execution of the computer program.

17. The method of claim 16, wherein the optimizing further comprises retrieving the optimized executable code from a storage device, in response to determining that the optimized executable code was stored during the previous execution of the computer program and that the system's attributes have not changed since the previous execution of the computer program.

18. The method of claim 16, wherein the optimizing further comprises generating the optimized executable code, in response to determining that the optimized executable code was not stored during the previous execution of the computer program or that the system attributes have changed since the previous execution of the computer program.

19. The method of claim 18, further comprising a logic unit for storing the optimized executable code and the collected information in a local storage device.

20. A computer program product comprising a computer readable medium having logic code stored thereon, wherein the logic code when executed on a computer causes the computer to:
receive a request to execute a computer program on a computing system;
load executable code generated for the computer program into memory;
optimize the executable code during the loading; and
execute the optimized executable code.
